(19) United States
(12) Patent Application Publication
(10) Pub. No.: US 2017/0343142 A1
(43) Pub. Date: Nov. 30, 2017

(54) PIPE CONNECTING DEVICE USING ROTARY WEDGE

(71) Applicant: Sukyoon KIM, Incheon (KR)

(72) Inventor: Sukyoon KIM, Incheon (KR)

(21) Appl. No.: 15/536,656

(22) PCT Filed: Dec. 24, 2015
(86) PCT No.: PCT/KR2015/014245

§ 371 Date: Jun. 16, 2017

(30) Foreign Application Priority Data
Jan. 1, 2015 (KR) 10-2015-0000009
Dec. 22, 2015 (KR) 10-2015-0183732

(51) Int. Cl. F16L 37/092

(52) U.S. Cl. CPC F16L 37/0925

(57) ABSTRACT

A pipe connecting device comprises a connecting body including a first tube having a stop jaw at an end thereof and a second tube coupled to the first tube by a fastener and having an opening for insertion of a pipe, wherein a wedge groove is formed in the connecting body and includes rotary corners having a L-shaped cross section and surrounding a circumference of the pipe, rotary wedges each including a rotary part and an extension part, wherein the rotary part is provided in the wedge groove, has a semicircular cross section, and rotates while in tight contact with the rotary corners, and wherein the extension part is formed integrally with the rotary part, has teeth, and contacts the pipe, an elastic member contacting the rotary wedges to transfer a rotational force to the rotary wedges, and a sealing member embedded in the connecting body.

### CROSS-REFERENCE TO RELATED APPLICATIONS

This patent application is a national-stage application of International Patent Application No. PCT/KR2015/014245, filed on Dec. 24, 2015, which claims priority under 35 U.S.C. §119 to Korean Patent Application No. 10-2015-000009, filed on Jan. 1, 2015, and Korean Patent Application No.: 10-2015-0183732, filed on Dec. 22, 2105 in the Korean Intellectual Property Office, the disclosures of which are incorporated by reference herein in their entireties.

### TECHNICAL FIELD

The present invention relates to a pipe fastening and connecting device, and more specifically, to a pipe connecting device using a rotary wedge, in which large-caliber pipes as well as small-caliber pipes are easily and firmly connected in a one-touch manner, which is applied to steel pipes and PE pipes regardless of the pipe materials, in which the unit cost can be decreased by reducing the number of parts, which can be used as joints for piping with sealing functionality, in which resources may be recycled through separation of the pipes, and in which the construction time can be saved upon use thereof.

### DISCUSSION OF RELATED ART

A pipe connecting device is a component used to connect hollow pipes through which a fluid can flow. Compression-type and sleeve-type connecting devices have been developed in addition to conventional methods such as welding screws. Recently, sliding wedge type one-touch joints have also been developed.

In the case of the one-touch method, two or more pipes are connected to each other by inserting a pipe into the connecting device, and they are manufactured in various shapes such as a socket, an elbow, and T shape for use of pipe connection.

A typical example of such a conventional pipe connecting device is disclosed in Korean Patent Application No. 10-2008-0031902, entitled “object for connecting pipes,” which includes a connecting body 20 having an inclined surface, an O-ring 30, a sliding wedge 50, and a spring 40 as illustrated in FIGS. 1 and 2 thereof.

The connecting body 20 is formed with the inclined surface 24 to be gradually narrowed toward the inlet direction. The O-ring 30, the spring 40, and the sliding wedge 50 are inserted in order from the stop jaw. The spring 40 and the sliding wedge provided at the rear of the O-ring 3 are for fastening the pipe 1. The spring 40 allows the sliding wedge 50 to always ride on a slope toward a narrow portion of the conical space. The sliding wedge 50 is formed with teeth to come in contact with the pipe. When a pipe pulling force is applied, the sliding wedge 50 provides an infinite frictional force so that the sliding wedge and the pipe are integrated together.

When the pipe 1 is inserted, the pipe end comes into contact with the sliding wedge, and the sliding wedge 50 with teeth is slid on the inclined surface 24 and is positioned in the expanded space to be out of the outer diameter of the pipe. At this time, the spring 40 again pushes the sliding wedge along the inclined surface 24, so that the wedge is stuck in the narrow space of the conical space. The sliding wedge, which can no longer move, acts to secure the pipe by the teeth.

When the inserted pipe is pulled out, a release device is inserted to separate the sliding wedge 50 from the pipe to be pulled out.

### SUMMARY

The above-mentioned conventional one-touch pipe connection device is limited by being applied only to the connection of a small-caliber lightweight stainless steel pipe. Since the spring pushes the sliding wedge in the pipe length direction, it is difficult to uniformly apply a force to the entire wedge as the larger diameter increases. It is difficult to apply to a pipe connection having a large-caliber, and the connection device for a thick pipe is difficult to manufacture, and there is a disadvantage that the manufacturing cost is high and the economic efficiency is low.

Further, when a high pressure is applied to the fluid, it is difficult to remove the sliding wedge by sliding the sliding wedge into a narrow space between the pipe and the inclined surface, which makes it difficult to remove the pipe.

The applicant of the present invention has developed a pipe connecting device using a rotary wedge that can be manufactured with various materials such as general steel pipe, stainless steel pipe, and synthetic resin, and that can connect a pipe having a large-caliber or a thick pipe by a one-touch method.

In order to address the issues, the present invention uses a rotary wedge. A pipe connecting device using a rotary wedge according to the present invention comprises a connecting body having a wedge groove with a rotary corner having a L-shaped cross section as a condition for smoothly operating the rotary wedge; a rotary wedge comprising a rotary part formed to have a semicircular cross section and brought into tight contact with the rotary corner of the wedge groove and an extension part formed integrally with the rotary part, contacting each of an elastic member and the pipe, and having a teeth contacting the pipe; an elastic member elastically repulsed in contact with the rotary wedge; and a sealing member. When the pipe is inserted, the rotary part of the rotary wedge is rotated in tight contact with the rotary corner of the wedge groove around the rotary part by the action of the elastic member, and the teeth firmly hold the pipe, thereby enabling the connection of the pipe.

The connecting body of the present invention comprises a first tube in which the pipe is inserted and a second tube forming an inlet. The wedge groove having a substantially U-shaped cross section and including the rotary corner with a L-shaped cross section and abutting the rotary part of the rotary wedge is formed inside the connecting body. The wedge groove has a ring shape to surround the circumferential surface of the pipe and to receive each rotary wedge. The first tube and the second tube are detachably screwed together.

The teeth of the rotary wedge may be overlappingly disposed so that the distance between the tips of the teeth and the rotary axis is increased as the teeth come close to a stop jaw, thereby overcoming the tolerance of the large-caliber pipe.

The elastic member of the present invention serves to rotate the rotary wedge by pushing the teeth of the rotary wedge towards the center of the circle and is installed inside the wedge groove to achieve a complete one-touch method.

The pipe connecting device using the rotary wedge of the present invention has a simple structure in which the rotary wedge is rotated by the elasticity of rubber or a leaf spring as well as the amount of working of the connecting body is small because the pipe is fastened by rotating the rotary wedge in a small space, and thus, it is economical due to a small number of parts. Further, it can accomplish connection work by one-touch operation regardless pipe material, and thus can shorten the working period. The rotary corner having a cross-sectional shape of “L” which guarantees the stable rotation of the rotary wedge is easily manufactured to have economic benefit, and the elastic member applies the three from the circumferential surface to the center of the circle, so that the function is maintained even if the size of the connecting device is increased or the material is changed, and thus it can be applied to connection of various kinds of pipes such as seamless pipe, welded pipe, thin pipe, and PE pipe and has a wide range of application.

The connecting device of the present invention can be applied to joints such as a socket, an elbow, and T shape by connecting several pieces to one body and installing the inlets in various directions.

Further, the present invention is a useful invention for achieving recycling of resource because pipes can be easily separated.

### BRIEF DESCRIPTION OF THE DRAWINGS

FIG. 1 is a schematic exploded perspective view of a pipe connecting device using a conventional sliding wedge;

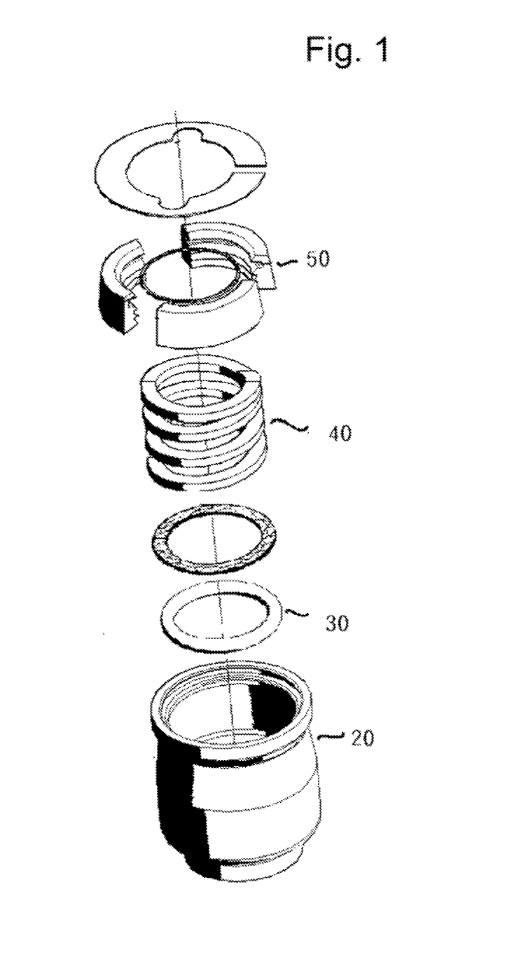

FIG. 2 is a schematic assembly cross-sectional view of the pipe connection device of FIG. 1;

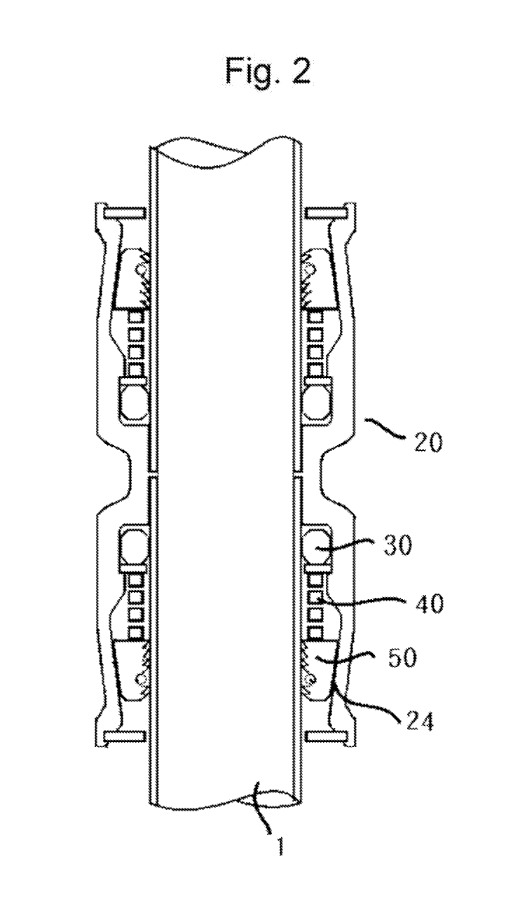

FIG. 3 is a perspective view showing an example of a rotary wedge of the present invention;

FIG. 4 is a perspective view of an example of an elastic member having a cylindrical leaf spring of the present invention;

FIG. 5 is a perspective view of an elastic member made of rubber of the present invention which is made in one body along with a sealing member and an isolation wall;

FIG. 6 is a partial perspective view showing an assembled state of a rotary wedge and an elastic member in a first embodiment;

FIG. 7 is an exploded perspective view of a pipe connecting device using a rotary wedge using an elastic member of a cylindrical leaf spring of the present invention according to the first embodiment;

FIG. 8 is a schematic assembly cross-sectional view of the connecting device of FIG. 7;

FIG. 9 is an operational state diagram showing a state in which a pipe is inserted into a connecting body in the first embodiment;

FIG. 10 is an operational state diagram showing a state in the insertion of the pipe is complete, following FIG. 9;

FIG. 11 is a partial perspective view showing an assembled state of a rotary wedge and an elastic member in a second embodiment;

FIG. 12 is an exploded perspective view showing a connecting device using a rubber elastic member formed in one body with a sealing member and an isolation wall according to the second embodiment;

FIG. 13 is a schematic assembly cross-sectional view of the connecting device of FIG. 12;

FIG. 14 is a partial perspective view showing an assembled state of a rotary wedge provided with a rotary projection and a torsion spring in a third embodiment;

FIG. 15 is an exploded perspective view showing a pipe connecting device using a torsion spring according to the third embodiment; and

FIG. 16 is a schematic assembly cross-sectional view of the connecting device of FIG. 15.

### DESCRIPTION OF REFERENCE DENOTATIONS

1: pipe

100, 200, 300: pipe connection device using a rotary wedge

110, 210, 310: connecting body

111, 211, 311: first tube

112, 212, 312: second tube

113, 213, 313: stop jaw

114, 214, 314: rotary corner

115, 215, 315: wedge groove

217: isolation wall

118, 218, 318: tube fastener

119, 219, 319: tight-contacting part

120, 220, 320: elastic member

122, 222, 322: resilient part

123: bent part

125, 325: elastic member coupler

130, 230, 330: rotary wedge

131, 231, 331; rotate part

133, 233, 333: extension part

134, 234, 334: tooth

135, 235, 335: false tooth

136, 236, 336: rotary projection

140, 240, 340: sealing member

141: Washer

### DETAILED DESCRIPTION OF EXEMPLARY EMBODIMENTS

The present invention relates to a pipe connecting device using a rotary wedge for connecting pipes to each other using the rotary wedge. The pipe connecting device of the present invention includes a connecting body having a wedge groove, which is a space for receiving a rotary wedge, the rotary wedge, an elastic member, and a sealing member. One end of the body has a stop jaw that halts the pipe.

The present invention focuses on the rotary wedge for fastening the pipe. The rotary wedge, the elastic member, and the wedge groove are designed to engage with one another, and the above elements are organically related to achieve an optimum design according to the applicable field. The rotary wedge is installed in the wedge groove, which is a space surrounding the pipe inside the connecting body, is rotated by the aid of the elastic member that provides a rotational force, and fastens the pipe. The sealing member is usually installed closer to the stop jaw than other parts and is responsible for airtightness.

Hereinafter, the shape and function of the connecting body, the rotary wedge, the wedge groove, the elastic member, and the sealing member are described. For convenience, reference denotations are added for the first embodiment, and reference numerals used only for particular embodiments will be given to the particular embodiments.

The connecting body 110 of the present invention includes a first tube 111 that is open toward an incoming pipe and has a stop jaw 113 at an end thereof to limit the amount of insertion of the pipe, a second tube 112 that is coupled to the first tube and forms an inlet, a wedge groove 115 that is a space in which a rotary wedge 130 is installed, and a rotary corner 114 provided in the wedge grove 115 and having a L-shaped cross section for allowing the rotary wedge to rotate smoothly in place. Here, the tube refers to it having a cylindrical shape.

The first tube 111 and the second tube 112 are screwed together to complete the connecting body 110. The second tube comes in tight contact with the outside of the first tube, or a cylindric part thereof is inserted into a space inside the first tube, so that the second tube is coupled with the first tube. Providing a sealing member 140 between the stop jaw 113 and the wedge groove 115 leads to easier manufacture and are economical product design. An economical design is possible when the elastic member 120 is appropriately selected and a washer 141 is additionally provided between rotary wedge 130 and the sealing member 140. Further, tight-contacting part 119 is generally provided between the stop jaw 113 and the edge groove 115 to secure a sufficient length of tight contact portion necessary for fastening the pipe 1.

The first tube and the second tube each are in charge of one surface of a cross section of the rotation corner of the wedge groove. The rotary wedges may be divided by isolation walls 217 to separately receive each rotary wedge, thereby preventing them from being forced to get together in one direction even when the pipe rotates. When multiple holes provided in the second tube 112 and the circumferential surface of the first tube 111 constitute the wedge groove 115, the rotary wedges may be installed in whatever number of layers, enabling the manufacture of connecting devices for use at high pressure.

The rotary edge 130 of the present invention is rotated in contact with the elastic member 120 while being stuck in the rotary corner 114 when the pipe 1 is inserted, thereby securely fastening the pipe 1. The rotary wedge 130 includes a rotary part 131 provided in tight contact with the rotary corner 114 and an extension part 133 integrally formed with the rotary part to contact each of the elastic member 120 and the pipe 1. Teeth 137 for fastening the pipe 1 are formed in the extension part 133 which is in contact with the pipe 1.

Since the rotary part 131 formed in the rotary wedge 130 has a semicircular shape in a cross section and is inserted into the rotary corner 114 of the wedge groove 116, the rotary wedge 130 is capable of rotating in place when the pipe is inserted or when a force in the opposite direction is applied thereto.

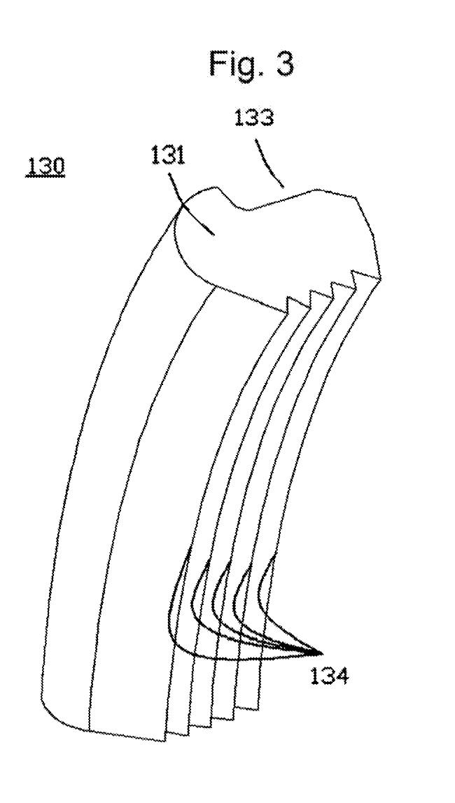

Preferably, a plurality of layers of teeth 137 are overlappingly formed in a portion, which contacts the pipe 1, of the extension part 133 of the rotary wedge. The layers of teeth 137 are configured so that the distance between the rotation axis of the rotary part 131 and the blade edge becomes gradually longer as they are further away from the inlet 111 of the connecting body 110, to thereby accommodate the tolerance of the pipe 1. That is, the length between the rotary axis and a blade end of the tooth closest to the inlet of the connecting body 100 is formed to be the shortest, so that it is in contact with the pipe 1 having a large-caliber. The lengths between the rotary axis and the blade ends of the teeth 137 gradually located farther from the inlet are made larger so that pipes 1 having different diameters can be fastened. When a line connecting the respective blade ends of the teeth 137 is formed in an arc shape, as the stress is increased during the reverse rotation of the rotary wedge 130, all of the teeth 137 bite into the pipe 1 so that the connection of the pipe 1 can be reinforced. Such a rotary wedge shape is shown in FIG. 3.

Multiple rotary wedges 130 each of which is formed in such an arc shape as one obtained by dividing a donut at predetermined angles in order to fasten the pipe 1 are arranged along a circumference thereof. The rotary wedges are assembled to tightly contact the elastic member 120 so that the rotary wedges can rotate smoothly through an elastic force of the elastic member 120 according to the insertion of the pipe 1. Preferably, the rotary wedges are densely arranged for a high-pressure pipe, and the interval between the rotary wedges is widened for a low-pressure pipe. If more contact surfaces are required, the rotary wedges may be overlappingly arrayed. The rotary wedges 130 being divided at 30 degrees are shown in the first to third embodiments, but the rotary wedges divided at larger angles or smaller angles may also be arranged.

The elastic member 120 of the present invention rotates the rotary wedges in contact with the rotary wedges 130. The elastic member 120 pushes the teeth 137 of the wedges toward the pipe 1 and brings them into tight contact with each other. The teeth 137 formed in a forward direction of the incoming pipe 1 allow the rotary part 131 to be rotated in the forward direction to guide the pipe 1 when the pipe is inserted. However, when the pipe moves in the reverse direction, the elastic member 120 continuously pushes the teeth 137 of the rotary wedges toward the pipe, and the rotary part 131 positioned in the rotary corner 114 of the wedge groove 115 cannot rotate any longer, so that the teeth 137 bite into the pipe 1 and obstructs the movement of the pipe.

The elastic member 120 can be made of various materials such as a rubber material having high elasticity, a coil spring, or a leaf spring. The elastic member of the present invention is conveniently divided into a part that keeps it in shape and a resilient part 122 that elastically repulses to give a rotational force to the rotary wedge.

When the resilient part 122 of the elastic member is installed on the top surface of the rotary wedge, a coil spring or a leaf spring is suitable because the wedge is pulled from the upper part, but their assembly and fastening are somewhat difficult. If it is installed on the bottom surface, it faces the insertion direction of the pipe, resulting in an increased resistance upon insertion of the pipe. Therefore, it is difficult to insert the pipe. The resilient part 122 of the elastic member 120 according to the present invention is positioned between the circumferential surface of the wedge groove 115 and the rotary wedges 130 to push the rotary wedge teeth 137 from the circumferential surface toward the center of the pipe, leading to more efficiency. This is why the resistance, when inserting pipe 1, is small, the rotational force applied to the rotary wedges is large, and thus it is easy to manufacture and install the same.

The present invention provides an elastic member made of a cylindrical leaf spring, a rubber material elastic member in the form of a ring having the resilient part, and an elastic member made of a torsion spring disposed on both sides of the rotary wedge.

The use of the elastic member 120 made of the leaf spring gives the advantage that heat resistance is increased as compared with the elastic member made of the rubber. The leaf spring may have various shapes, but the present invention proposes a cylindrical leaf spring in the first embodiment. The elastic member includes the resilient part 122 having a hinge shape, which is bent and branches off from a cylindrical plate. The branching direction can be either the longitudinal direction of the pipe or the direction of the circle of the cylinder, but the leaf spring having the resilient part 122 bent along the circular surface is more advantageous. This is why a design may be made by adjusting the height not to contact the rotary part 131 of the rotary wedge 130, which is advantageous in light of corrosion and it is also convenient to fasten it to the second tube 112.

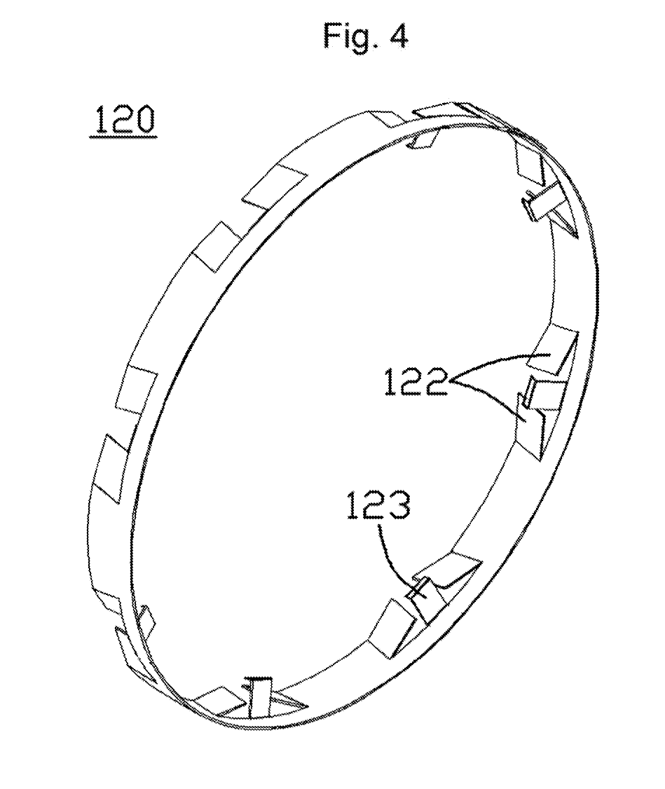

Further, it is preferred that the elastic member 120 of the leaf spring material is extended in the center direction so as to support the bottom so that the rotary wedges 130 can rotate in place and further includes a bent part 123 bent toward the inlet for insertion of a false tooth 135 of the rotary wedge. Such leaf spring is described in FIG. 4. When the leaf spring is used, a washer 141 is additionally provided between a sealing member and the rotary wedge so that the sealing member stably functions when a water pressure is generated.

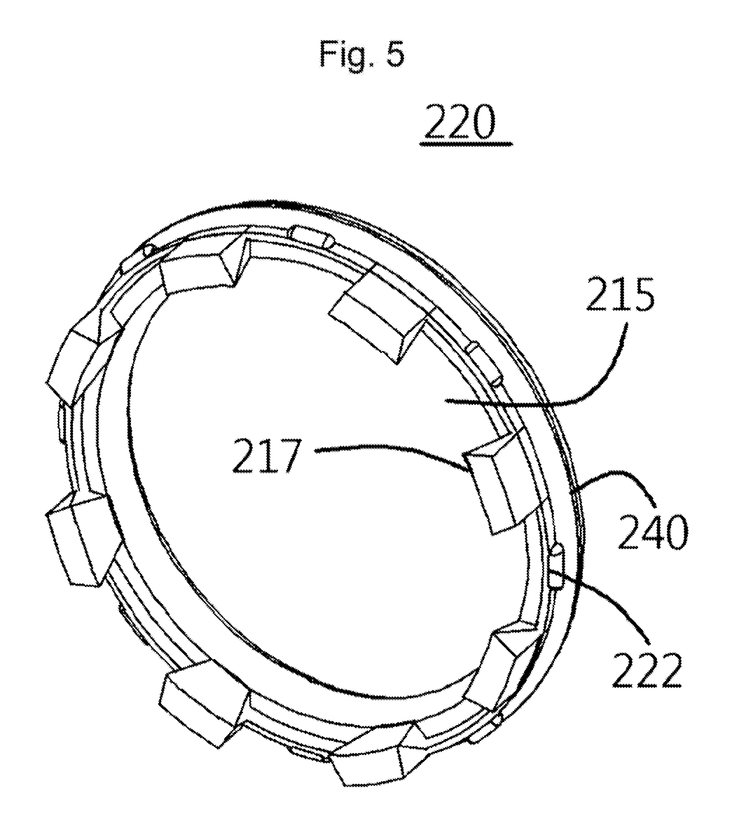

An elastic member 220 made of rubber, which is a polymer compound, can be conveniently fabricated in one body along with a sealing member 240. The rubber material elastic member 220 of the present invention is manufactured in one body along with the sealing member to provide a rotating force to the rotary wedge, and the isolation walls 217 are provided between rotary wedges 230 to prevent the rotary wedge from escaping off and to prevent infiltration of rainwater and sewage. Thus, it is useful for non-pressure or low-pressure connections. In the second embodiment, the rubber material elastic member 220 is applied, and the elastic member 220 is illustrated in FIG. 5. It is useful that when the rotary wedge has no false tooth, a wedge groove 215 having a trapezoidal shape when viewed from the center of the circle can be used to prevent the detachment of the rotary wedge and increase the area of the teeth of the rotary wedge.

In the third embodiment, a torsion spring is shown as an elastic member. The torsion springs 320 provided on both sides of the rotary wedge smoothly rotate the rotary wedge 330, so that they are suitable for a high-pressure hydraulic test jig or a large pipe connecting apparatus. In this case, it is preferable that a rotary protrusion 336 is provided so that the rotary wedge 330 does not escape off and that the rotary protrusion 336 is inserted into the coil of the torsion spring. That is, the rotary wedge fastening device and the torsion spring can be suitably used to exhibit the optimum function. A resilient part 322 for transmitting a rotational force is located between the circumferential surface of a wedge groove 315 and the rotary wedge. The torsion spring 320 is preferably installed in a space provided in the wedge groove 315 and fastened to the first tube 311 using a coupler 325. Although the coupler 325 can be used in various ways, the present invention suggests the use of ‘U’ shaped clips.

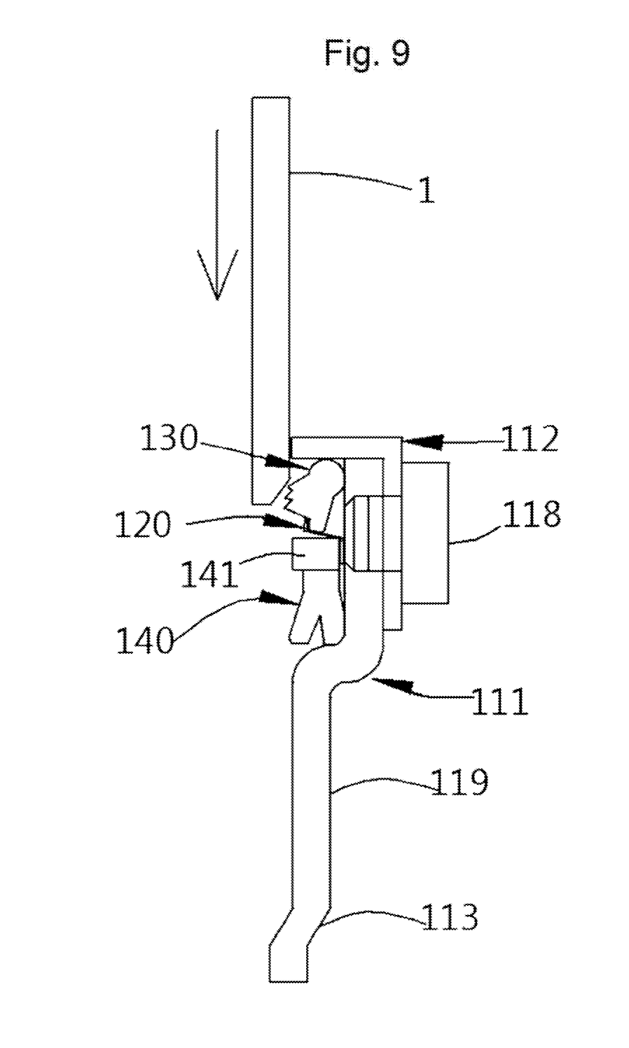

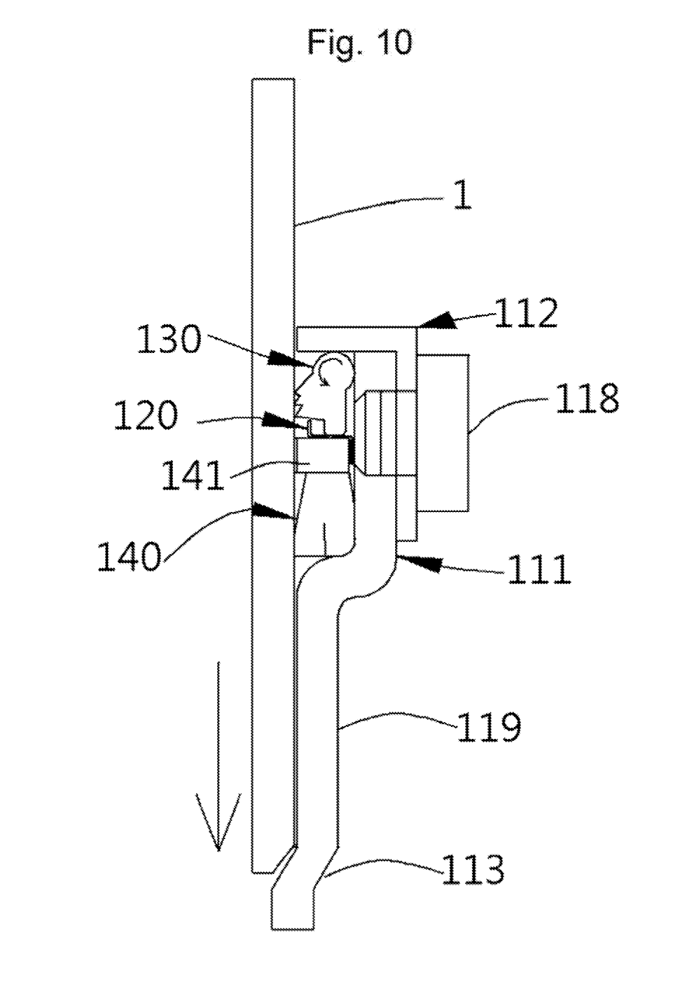

The pipe connecting device of the present invention operates as follows. Such operation is representatively described with reference to the first embodiment and illustrated in FIGS. 9 and 10.

When the pipe 1 is inserted through the inlet, the pipe contacts the extension parts 133 of the rotary wedges 130 and then pushes the rotary wedges 130 so that the forward rotation operation is performed with respect to the rotary parts 131 while compressing the elastic member 120. As a result, a side surface of the pipe comes in contact with the teeth 137 formed on the extension parts 133 of the rotary wedges, and the teeth are placed in the forward direction, so that the pipe 1 is easily inserted.

Further, the insertion of the pipe 1 is limited by being caught by a stop jaw 117 formed in the second tube. When the pipe 1 is caught by the stop jaw 117, the pipe 1 is firmly fastened by the stop jaw 117 and the rotary wedges 130.

When a force is applied in the direction of withdrawal, the rotary wedge 130, which has already been pushed into a minimum space while being stuck in the rotary corner 114 having a L-shaped cross section by the elastic member 120, can no longer rotate in the reverse direction. Therefore, the teeth 137 abutting the pipe 1 bite into the pipe, preventing the pipe 1 from being separated. That is, by the elastic repulsion of the elastic member 120, the rotary wedge 130 acts as a hinge or a wedge in the space between the expansion part and the pipe 1, and the reverse direction of the force acts on the teeth 137 of the rotary wedge 120 to strongly press the pipe 1, thereby preventing the pipe from escaping off.

It is preferable to add a rotary wedge fastening device to prevent the detachment of the rotary wedge and so that the rotary wedge rotates in place during assembly or disassembly. Various means are available depending on the diameter of the pipe and uses.

A first fastening means includes the rotary protrusion 136 as rotary protrusions on both sides of the rotary part 131 of the rotary wedge and a corresponding space in the wedge groove 115. The first fastener is suitable for a large connection device. A second fastening means is to provide a false tooth 135 extending in the lengthwise direction of the pipe on the extension part 133 of the rotary wedge so that a corresponding groove into which the false tooth 135 is fitted is usually provided in the elastic member. The second fastening means is a useful method for small-caliber connecting devices. A third method is to use the fan shape of the rotary wedge 130, wherein the front of the wedge groove is shaped as a trapezoid when viewed from the center of the circle. In this way, the rotary part of the rotary wedge is stuck in the trapezoidal small part and is thus prevented from escaping off to the center part, and the tooth-formed part can be directed to the center part while rotating. Thus, the performance is guaranteed. The third method is useful when the wedge groove structure includes a rubber material or for small-caliber connecting devices that can allow the rotary wedge 130 to be easily released even if tightly fitted to the wedge groove 115.

The pipe connecting device using the rotary wedge according to the present invention can use various combinations or selections of the rotary wedge fastening devices and part shapes depending on the material, the working pressure, and the caliber of the pipe.

Now described are three embodiments for the pipe connecting device using the rotary wedge of the present invention according to how to configure the rotary wedges, the elastic member, and the wedge groove.

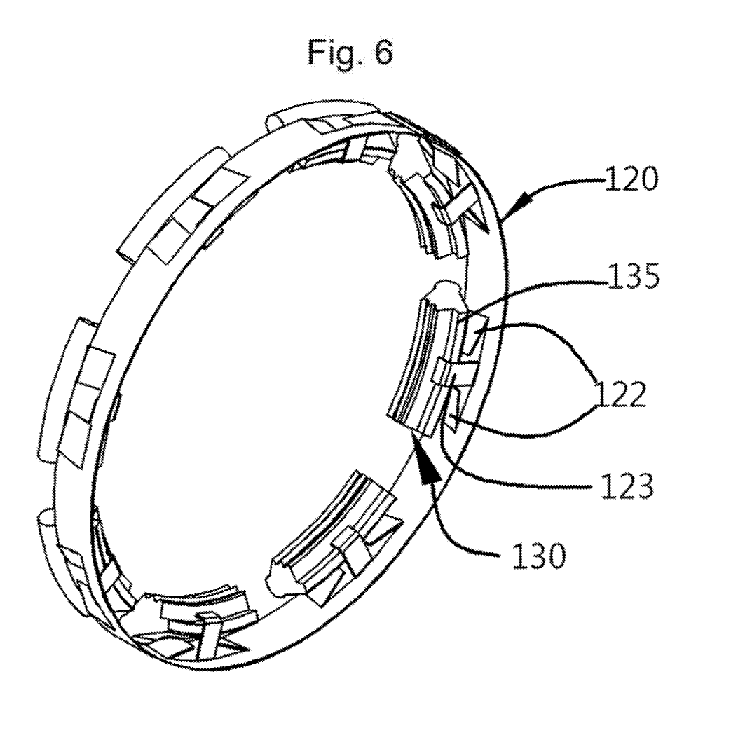

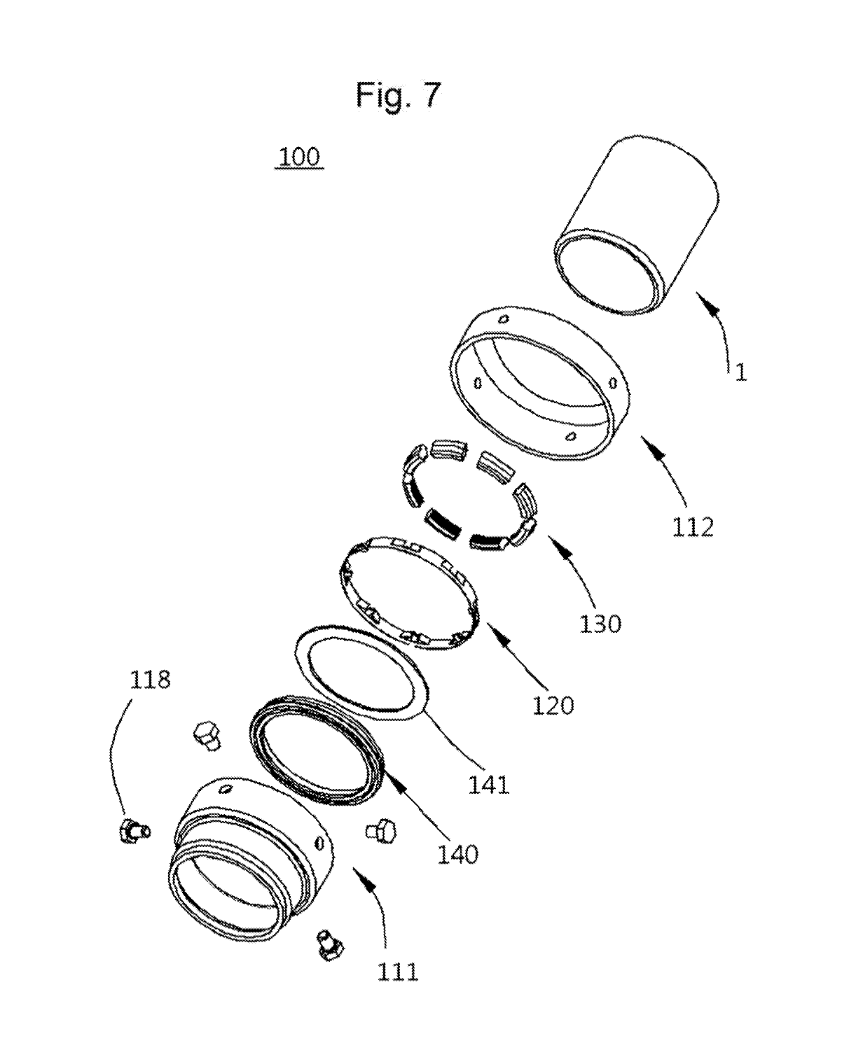

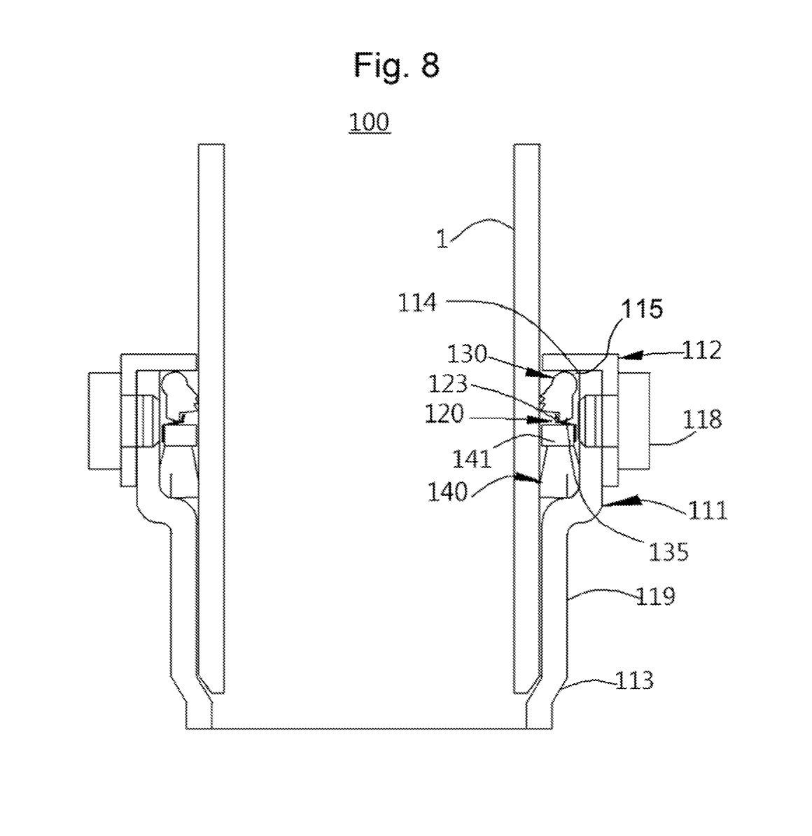

The connecting device 100 of the first embodiment shown in FIGS. 6, 7, and 8 uses a cylindrical leaf spring, and the second tube 112 is coupled to the first tube in such a manner as to surround the outside of the first tube. A washer is provided between the rotary wedges and the sealing member to correspond to the fluid pressure.

The leaf spring 120 of the present invention has a pair of resilient parts 122 each of which is shaped as a hinged window and branches off from the cylindrical surface and bends toward the center. The pair of resilient parts 122 correspond to one rotary wedge 130. A bent part 123 is provided between the resilient parts 122, which extends toward the center of the circle and has an end bent toward the inlet. The false tooth 135 of the rotary wedge is fitted into the bent part 123 to prevent the rotary wedge from escaping off and to assist rotation in place.

The sealing member 140 of this embodiment is shown to be shaped as a U-shaped packing. Such design of the sealing member 140 helps the rotary wedge to rotate in place because the sealing portion is compressed in the circumferential direction when the pipe 1 is inserted, thus reducing the influence in the longitudinal direction.

The sealing member 140 and the washer 141 are inserted into the first tube 111, and the rotary wedges 130 and the elastic member 120 are then assembled. The assembly is installed in the first tube. The first tube 111 and the second tube 112 are fastened with the fastening screws 118, completing the connecting device 100 of the present embodiment. Upon pulling out the pipe 1, the fastening screws 118 are loosened, and the second tube 112, the rotary wedges 130, and the leaf spring 120 are removed.

This embodiment is suitable for pressure piping, such as water supply piping and fire piping.

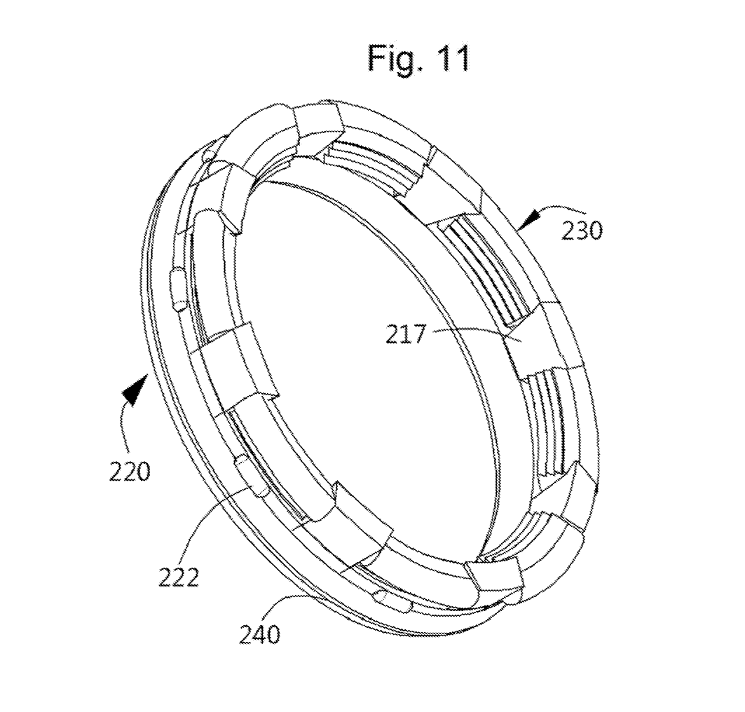

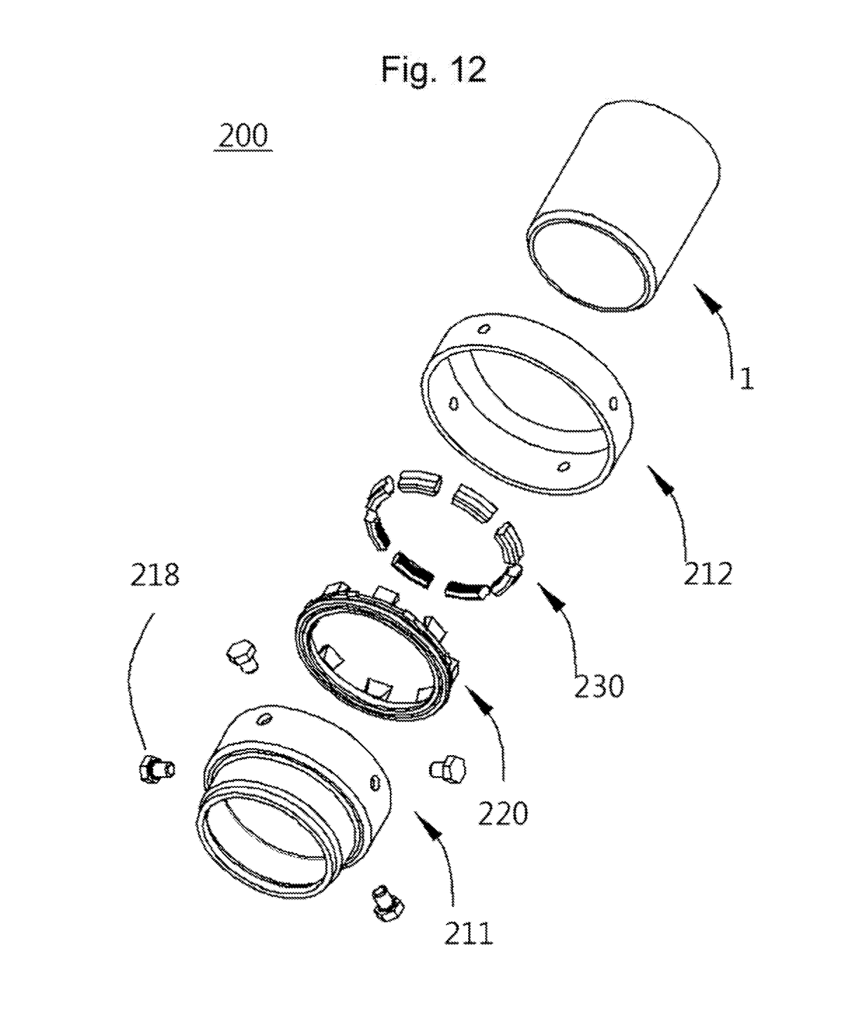

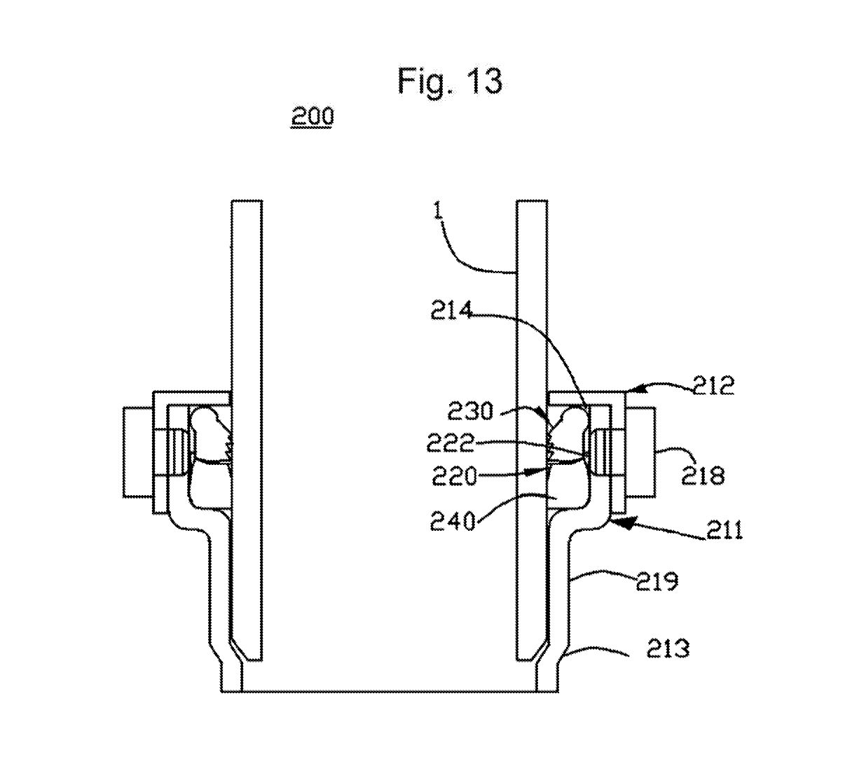

The second embodiment shown in FIGS. 11, 12, and 13 is directed to a connecting device 200 using the elastic member 220 made of rubber, and this embodiment is an example in which the trapezoidal wedge grooves 215 and the fan-shaped rotary wedges 230 are assembled. It is very economical for use in various fields such as pipe structure connecting devices, electric wire pipe connecting devices, and general pipe connection devices. Since the elastic member 220 of this embodiment shown in FIG. 5 is designed to integrate the sealing member 240 and the isolation walls 217 in one body, the elastic member 220 has the function of preventing the wedges form escaping off and a sealing function, as well as the elastic function using the elasticity of rubber.

In the case of using the elastic member 220 made of a rubber material, it is possible to add a false tooth 235 to the rotary wedge and provide a groove into which the false tooth is inserted. However, in this embodiment, the fan shape of the rotary wedge 230 may be used to prevent the rotary wedge 230 from escaping off. In other words, the wedge groove 215 is shaped as a trapezoid when viewed from the center, thereby disturbing the movement of the rotary part 231 of the rotary wedge while enabling the rotation of the rotary wedge extension part 233. This design is useful because the area of the teeth of the rotary wedge 230 can be increased. A washer and a sealing member may be added for use at high pressure.

The rotary wedge 230 is assembled into the wedge groove 215 provided in the elastic member 220 which is formed of rubber and is inserted into the first tube, and the first tube 111 and the second tube 212 are coupled together, completing the connecting device 200 of the present embodiment. When the pipe 1 is removed, the rotary wedge 230 is removed in a reverse order of the above sequence, and the work is then performed.

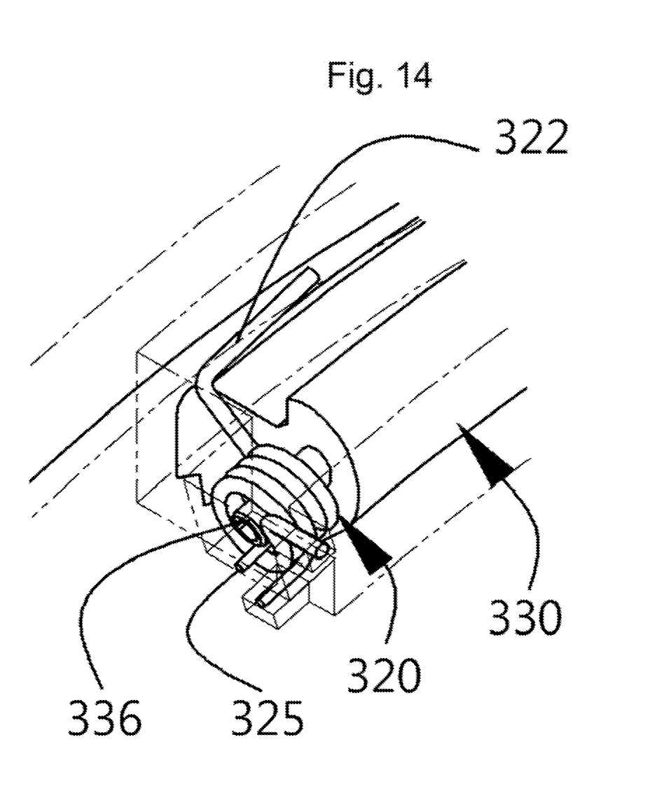

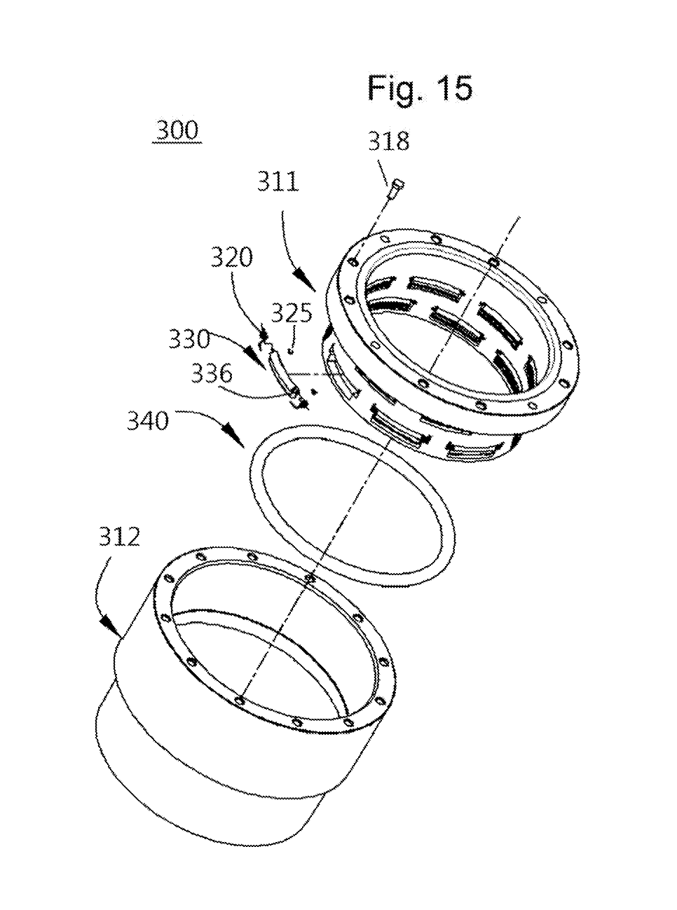

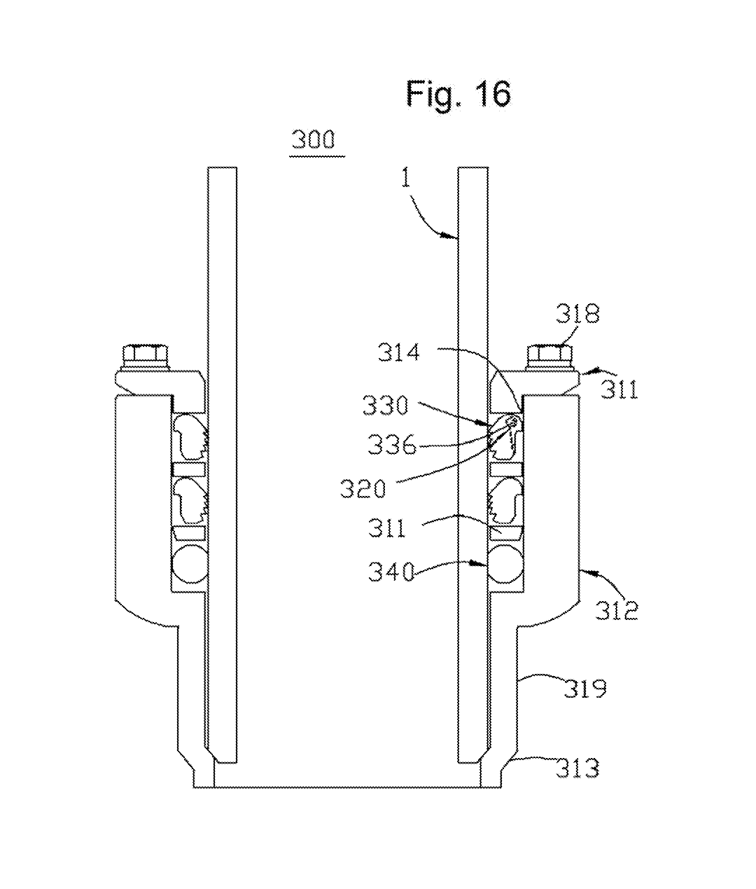

The connecting device 300 of the third embodiment shown in FIGS. 14, 15, and 16 is designed to rotate the rotary wedge 330 using the torsion springs 320, which are mounted on both sides of the rotary wedge. The resilient part 322 for transferring elasticity is rendered to be positioned between the circumferential surface of the wedge groove 315 and the rotary wedge 330. The rotary protrusion 336 is provided on the rotary wedge and a hole is provided in the second tube 312 for the wedge groove. The cylindrical part of the second tube is inserted and, coupled with the first tube, and the cylindrical part is provided with a hole to be in charge of the wedge groove 315.

The torsion spring 320 may be designed to operate smoothly on each rotary wedge and is therefore suitable for large joints. The rotary protrusion 336 of the rotary wedge 330 is inserted into the coil part of the torsion spring and is installed in the wedge groove 315, and then the torsion spring 320 is fastened to the second tube 312 using a U-shaped clip. Thereafter, the first tube 311 and the second tube 312 are coupled together, completing the connecting device 300 before the pipe is inserted. In FIG. 17, the torsion springs and the rotation protrusions are indicated by dotted lines for convenience.

When the pipe is removed, the screw 541 is loosened to separate the first tube 311 and the second tube 312 from each other. After removing the second tube 312, the work of removing the pipe is carried out. This design is suitable for large-caliber pipe connecting devices or hydraulic test jigs.

When a plurality of connecting devices are coupled together in one body and the respective inlets are fixated in various directions, various types of joints, such as sockets, elbows, and T-shaped connectors may be produced, thereby leading to an easier buildup of piping structures.

As described above, while the pipe connecting device using the rotary wedge has been particularly shown and described with reference to preferred exemplary embodiments of the present invention, it will be understood by those skilled in the art that various changes, modifications, and variations may be made without departing from the spirit of the present invention.

### INDUSTRIAL APPLICABILITY

The pipe connecting device using the rotary wedge according to the present invention may be suitably designed for various purposes by various combinations of components and is capable of one-touch connection for not only small-caliber pipes but also large-caliber pipes, so that working period and cost savings may be achieved in piping for water and sewage, firefighting, plant, and shipbuilding. As shown in the particular embodiments of the present invention, it can be applied to connecting devices for pressure pipes, connecting devices for low-pressure pipes, connecting devices for PE pipes, and designs for hydraulic jigs.

1. A pipe connecting device using a rotary wedge comprising:
a connecting body is a first tube and a second tube, wherein the first tube has an end open toward a pipe to be inserted and another end including a stop jaw to limit an amount of insertion of the pipe, wherein the second tube is fastened to the first tube by a fastener and forms an inlet through which the pipe is inserted, and wherein the connecting body is provided with a wedge groove including rotary corners having a L-shaped cross section as a space surrounding a circumference of the pipe;
a plurality of rotary wedges including rotary parts and extension parts, wherein the rotary parts are provided in the wedge groove, have a semicircular cross section, and rotate while in tight contact with the rotary corners, and wherein the extension parts are formed integrally with the rotary parts, have teeth, and contact the pipe;
an elastic member contacting the rotary wedges to transfer a rotational force to the rotary wedges; and
a sealing member embedded in the connecting body to perform a sealing function.

2. The pipe connecting device of claim 1, wherein two sides of the L-shaped, cross section of each of the rotary corners, respectively, include an inner circumferential surface of the first tube and a surface provided by the second tube.

3. The pipe connecting device of claim 1, wherein isolation walls are provided in the wedge groove to detachably receive the rotary wedges.

4. The pipe connecting device of claim 1, wherein the wedge groove includes a plurality of holes provided in the second tube.

5. The pipe connecting device of claim 1, wherein the rotary wedges each has an arc shape obtained by dividing a donut shape surrounding the pipe.

6. The pipe connecting device of claim 1, wherein the teeth of the rotary wedges are formed of a plurality of layers, wherein the teeth are configured so that distances between a rotation axis of the rotary parts and the teeth gradually increase as the teeth are further away from the inlet of the connecting body, and wherein a line connecting the saw blade ends has an arc shape.

7. The pipe connecting device of claim 1, wherein the elastic member comprises a resilient part performing elastic repulsion and positioned between an inner circumferential surface of the wedge groove and the rotary wedges.

8. The pipe connecting device of claim 7, wherein the elastic member is a leaf spring including the resilient part that branches off from a cylindrical plate in a central direction thereof.

9. The pipe connecting device of claim 8, wherein the resilient part is shaped as a hinged window.

10. The pipe connecting device of claim 8, wherein the leaf spring is partially ended in the central direction thereof and further has a bent part bent toward the inlet.

11. The pipe connecting device of claim 7, wherein the elastic member is a torsion spring having a coil part located on a side surface of the rotary wedges.

12. The pipe connecting device of claim 1, wherein the elastic member is fastened to the connecting body by a coupler.

13. (canceled)

14. The pipe connecting device of claim 3, wherein the elastic member is made of a rubber material, and wherein the elastic member is formed in one body along with the sealing member and the isolation walls.

15. The pipe connecting device of claim 1, wherein a washer is additionally provided between the sealing member and the rotary wedges.

16. The pipe connecting device of claim 1, further comprising a rotary wedge fastener allowing the rotary wedges to rotate in place without escaping off.

17. The pipe connecting device of claim 16, wherein the rotary wedge fastener includes protrusions formed on both sides of each of the rotary part.

18. The pipe connecting device of claim 16, wherein the rotary wedge fastener comprises a false tooth extending in a lengthwise direction of the pipe and formed in the extension part between each of the rotary part and the teeth.

19. The pipe connecting device of claim 16, wherein in the rotary wedge fastener, a wedge hole is shaped as a trapezoid when viewed from a centrifugal point.
